(19) United States
(12) Patent Application Publication
(10) Pub. No.: US 2011/0199584 A1
(43) Pub. Date: Aug. 18, 2011

(54) DISPLAY DEVICE AND PROJECTION DISPLAY DEVICE

(75) Inventors: Yusuke YAMAMOTO, Osaka-city (JP); Yuji HASHIBA, Kizugawa-city (JP); Toshihiro SARUWATARI, Kishiwada-city (JP)

(73) Assignee: SANYO ELECTRIC CO., LTD., Moriguchi-City (JP)

(21) Appl. No.: 13/027,725

(22) Filed: Feb. 15, 2011

(30) Foreign Application Priority Data
Feb. 15, 2010 (JP) 2010-030161

(51) Int. Cl. G03B 21/14; G09F 13/04

(52) U.S. Cl. 353/74; 362/97.1

(57) ABSTRACT

A display device includes a display window, an light emitting portion which is disposed away from the display window by a predetermined distance, and a light guiding portion which is disposed between the display window and the light emitting portion, and which guides light from the light emitting portion to the display window. In this arrangement, the light guiding portion includes a distal end surface located on the side of the display window, and a base end surface located on the side of the light emitting portion. The base end surface has an area larger than an area of the distal end surface. Further, at least a part of the light guiding portion is formed into a tapered portion whose cross sectional area is gradually reduced, as the light guiding portion extends from the base end surface toward the distal end surface.

This application claims priority under 35 U.S.C. Section 119 of Japanese Patent Application No. 2010-30161 filed Feb. 15, 2010, entitled “DISPLAY DEVICE AND PROJECTION DISPLAY DEVICE”. The disclosure of the above application is incorporated herein by reference.

### BACKGROUND OF THE INVENTION

1. Field of the Invention

The present invention relates to a display device for emitting light from a light emitter through a display window, and to a projection display device incorporated with the display device.

2. Disclosure of Related Art

Conventionally, a projection display device (hereinafter, called as a “projector”) is provided with a display device for displaying information relating to the device such as an operating condition thereof. For instance, the display device may be configured in such a manner that light from light emitters such as LEDs disposed inside a main body cabinet is emitted through plural display windows formed in the main body cabinet.

In the above arrangement, a light guiding member (a light guide) made of a transparent resin may be disposed between a light emitter and a display window. The light guiding member may be formed into a columnar member having a uniform cross sectional area from a distal end surface thereof on the side of the display window to a base end surface thereof on the side of the light emitter. Light emitted from the light emitter is propagated through the light guiding member, and is guided to the display window.

Generally, the shape and the size of a display window are determined depending on the design of a main body cabinet. For instance, there is a case that the display window has a relatively small size so that the display window is less perceivable on the main body cabinet. In such a case, if the cross sectional area of the light guiding member is reduced so as to conform with the size of the display window, the amount of light to be supplied from the light emitter to the light guiding member may be reduced. As a result, the light emission amount through the display window may be reduced, and it may be difficult for the user to recognize light emission through the display window.

In particular, in the case where the display window and the light emitter are disposed away from each other with a relatively large distance, the length of a light guiding path by the light guiding member is increased. This may cause a problem of lowering the light emission amount through the display window.

### SUMMARY OF THE INVENTION

A display device according to a first aspect of the invention includes a display window, a light emitting portion which is disposed away from the display window by a predetermined distance, and a light guiding portion which is disposed between the display window and the light emitting portion, and which guides light from the light emitting portion to the display window. In this arrangement, the light guiding portion includes a distal end surface located on the side of the display window, and a base end surface located on the side of the light emitting portion. The base end surface has an area larger than an area of the distal end surface. Further, at least a part of the light guiding portion is formed into a tapered portion whose cross sectional area is gradually reduced, as the light guiding portion extends from the base end surface toward the distal end surface.

A projection display device according to a second aspect of the invention includes a main body cabinet; a display window which is formed in the main body cabinet, a circuit board which faces the main body cabinet; a light emitting portion which is disposed on the circuit board at a position away from the display window by a predetermined distance; and a light guiding portion which is disposed between the display window and the light emitting portion, and which guides light from the light emitting portion to the display window. In this arrangement, the light guiding portion includes a distal end surface located on the side of the display window, and a base end surface located on the side of the light emitting portion. The base end surface has an area larger than an area of the distal end surface. Further, at least a part of the light guiding portion is formed into a tapered portion whose cross sectional area is gradually reduced as the light guiding portion extends from the base end surface toward the distal end surface.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are perspective views showing an external arrangement of a projector embodying the invention.

FIGS. 2A and 2B are perspective views showing an internal arrangement of the projector as the embodiment.

FIG. 3 is a diagram showing an arrangement of an optical engine and a projection lens unit in the embodiment.

FIG. 4 is a diagram showing a positional relation between LEDs on a circuit board, and a light guiding member in the embodiment.

FIG. 5 is a diagram showing an arrangement of the light guiding member in the embodiment.

FIGS. 6A and 6B are diagrams for describing a structure as to how the light guiding member is mounted on an upper cabinet in the embodiment.

FIG. 7 is a diagram schematically showing a manner as to how light from a first LED is guided to a first display window by a first light guiding portion in the embodiment.

FIGS. 8A and 8B are diagrams for describing an arrangement of a light guiding member as a comparative example with respect to the embodiment.

FIG. 9 is a diagram showing a modification of the light guiding member.

The drawings are provided mainly for describing the present invention, and do not limit the scope of the present invention.

### DESCRIPTION OF PREFERRED EMBODIMENTS

In the following, an embodiment of the invention is described referring to the drawings.

In this embodiment, display windows 123a, 123b, and 123c correspond to display windows in the claims. LEDs 804, 805, and 806 correspond to light emitting portions in the claims. Light guiding portions 141, 142, and 143 correspond to light guiding portions in the claims. Blocking ribs 153 and 154 correspond to a light blocking wall in the claims. The description regarding the correspondence between the claims and the embodiment is merely an example, and the claims are not limited by the description of the embodiment.

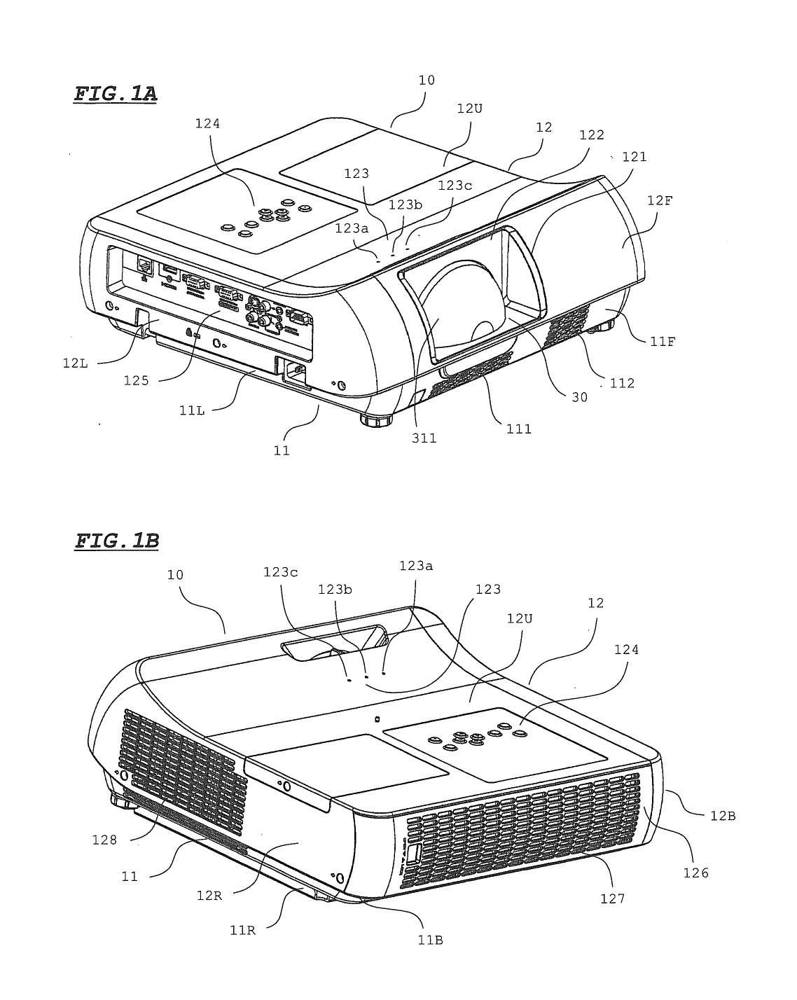

FIGS. 1A and 1B are perspective views showing an external arrangement of a projector. FIG. 1A is a perspective view of the projector when viewed from a front side thereof, and FIG. 1B is a perspective view of the projector when viewed from a rear side thereof.

Referring to FIGS. 1A and 1B, the projector is provided with a main body cabinet 10. The main body cabinet 10 is constituted of a lower cabinet 11, and an upper cabinet 12 to be covered onto the lower cabinet 11 from above.

The lower cabinet 11 has a box-like shape with a small height, and an upper surface thereof is opened. The lower cabinet 11 is configured in such a manner that a front surface 11F is higher than a left side surface 11L, a right side surface 11R, and a back surface 11B. The left side surface 11L and the right side surface 11R are configured in such a manner that front ends thereof gradually rise, and are continued to the front surface 11F.

The front surface 11F of the lower cabinet 11 is formed with an air inlet 111. The air inlet 111 is constituted of multitudes of slit holes. The front surface 11F of the lower cabinet 11 is further formed with a sound output port 112. Sounds in accordance with images are outputted through the sound output port 112 at the time of image projection.

The upper cabinet 12 has a box-like shape, and a lower surface thereof is opened. A front portion of the upper cabinet 12 is gradually curved upward over the entirety in left and right directions, and a front surface 12F thereof is directed slightly obliquely upward. The front surface 12F of the upper cabinet 12 is gradually curved when viewed from a lateral direction thereof, and is protruded obliquely upward from the front surface 11F of the lower cabinet 11.

The front surface 12F of the upper cabinet 12 is formed with a rectangular projection port 121 at a position closer to the left side surface of the upper cabinet 12 with respect to the center thereof. A housing portion 122 for housing a lens 311 corresponding to a front end of a projection lens unit 30 is formed at a rear position of the projection port 121.

An upper surface 12U of the upper cabinet 12 is formed with an indicator portion 123. The indicator portion 123 is constituted of a first display window 123a, a second display window 123b, and a third display window 123c. Light emitted from a corresponding LED is guided to the display window 123a, 123b, 123c by a light guiding structure to be described later.

The first display window 123a mainly displays information relating to an operating condition of the projector. When the projector is in a standby state, red light is emitted through the first display window 123a, and when the projector is in an operating state, green light is emitted through the first display window 123a. The second display window 123b mainly displays information relating to a temperature anomaly of the projector. If a temperature anomaly is detected resulting from a sharp rise of the temperature inside the projector, a emission of red light through the second display window 123b is repeated at a predetermined time interval. The third display window 123c mainly displays information relating to exchange of a light source lamp. In the case where a currently-used light source lamp is deteriorated, and it is the time when the light source lamp should be exchanged with a new one, red light is emitted through the third display window 123c.

The upper surface 12U of the upper cabinet 12 is further formed with an operation portion 124. A certain number of operation keys are provided on the operation portion 124. An AV terminal portion 125 is provided on a left side surface 12L of the upper cabinet 12, and various AV terminals are exposed on the left side surface 12L of the upper cabinet 12. AV (Audio Visual) signals are inputted to and outputted from the projector via the AV terminal portion 125.

A back surface 12B of the upper cabinet 12 is constituted of a detachable rear cover 126. The rear cover 126 is formed with an air inlet 127. The air inlet 127 is constituted of multitudes of slit holes. A right side surface 12R of the upper cabinet 12 is formed with an air outlet 128. The air outlet 128 is constituted of multitudes of slit holes. An external air drawn into the main body cabinet 10 through the air inlet 127 and the air inlet 111 of the lower cabinet 11 is discharged through the air outlet 128 after cooling heat generating parts disposed in the main body cabinet 10, such as liquid crystal panels and a light source lamp.

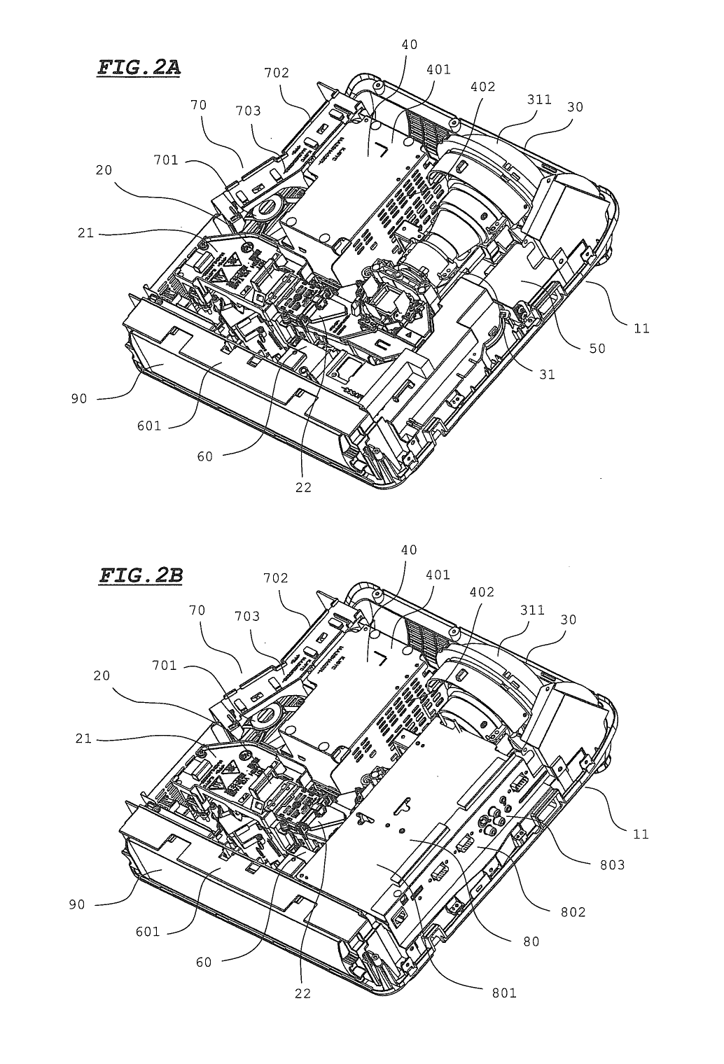

FIGS. 2A and 2B are perspective views showing an internal arrangement of the projector. FIG. 2A is a perspective view of the projector showing a state that the upper cabinet 12 and a control circuit unit 80 are detached, when viewed from the rear side thereof. FIG. 2B is a perspective view of the projector showing a state that the control circuit unit 80 is attached and only the upper cabinet 12 is detached, when viewed from the rear side thereof.

Referring to FIG. 2A, the lower cabinet 11 is internally provided with an optical engine 20, a projection lens unit 30, a main power source unit 40, a sub power source unit 50, a cooling unit 60, and an exhaust fan unit 70.

The optical engine 20 is provided with a light source portion 21 having a light source lamp, and an optical system 22 for modulating light from the light source portion 21 to generate image light. The optical engine 20 is disposed slightly rearward with respect to the center of the lower cabinet 11. The optical system 22 extends from the light source portion 21 to the projection lens unit 30 into an L-shape.

The projection lens unit 30 is disposed in front of the optical system 22, and slightly closer to the left side surface with respect to the center of the lower cabinet 11. The projection lens unit 30 is fixed to the lower cabinet 11 via a lens holder 31.

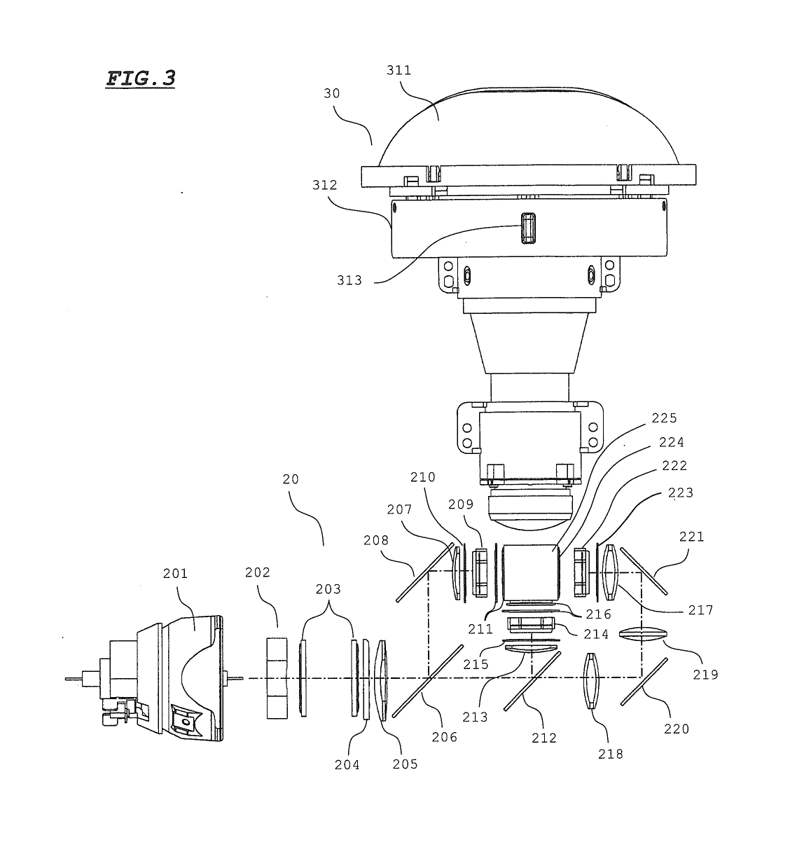

FIG. 3 is a diagram showing an arrangement of the optical engine 20 and the projection lens unit 30.

White light emitted from the light source lamp 201 is transmitted through a condenser lens 202, a fly-eye integrator 203, and a PBS array 204. The fly-eye integrator 203 is adapted to make the light amount distributions of light of the each of the colors to be irradiated onto liquid crystal panels (which will be described later) uniform, and the PBS array 204 is adapted to align polarization directions of light directed toward a dichroic mirror 206 in one direction.

Light transmitted through the PBS array 204 is transmitted through a condenser lens 205, and is entered into the dichroic mirror 206.

The dichroic mirror 206 reflects only light (hereinafter, called as “B light”) in a blue wavelength band, and transmits light (hereinafter, called as “G light”) in a green wavelength band and light (hereinafter, called as “R light”) in a red wavelength band, out of the light entered into the dichroic mirror 206.

B light reflected on the dichroic mirror 206 is irradiated onto a liquid crystal panel 209 for B light in a proper irradiation state by a lens function of the condenser lens 205 and a condenser lens 207, and reflection on a reflection mirror 208. The liquid crystal panel 209 is driven in accordance with an image signal for B light to modulate the B light depending on a driven state of the liquid crystal panel 209. One incident-side polarizer 210 is disposed on the incident side of the liquid crystal panel 209. B light is irradiated onto the liquid crystal panel 209 through the incident-side polarizer 210. Further, two output-side polarizers 211 are disposed on the output side of the liquid crystal panel 209, and B light emitted from the liquid crystal panel 209 is entered into the output-side polarizers 211.

G light and R light transmitted through the dichroic mirror 206 are entered into a dichroic mirror 212. The dichroic mirror 212 reflects the G light and transmits the R light.

G light reflected on the dichroic mirror 212 is irradiated onto a liquid crystal panel 214 for G light in a proper irradiation state by a lens function of the condenser lens 205 and a condenser lens 213. The liquid crystal panel 214 is driven in accordance with an image signal for G light to modulate the G light depending on a driven state of the liquid crystal panel 214. One incident-side polarizer 215 is disposed on the incident side of the liquid crystal panel 214, and G light is irradiated onto the liquid crystal panel 214 through the incident-side polarizer 215. Further, two output-side polarizers 216 are disposed on the output side of the liquid crystal panel 214, and G light emitted from the liquid crystal panel 214 is entered into the output-side polarizers 216.

R light transmitted through the dichroic mirror 212 is irradiated onto a liquid crystal panel 222 for R light in a proper irradiation state by a lens function of the condenser lens 205, 217, and relay lenses 218 and 219, and reflection on reflection mirrors 220 and 221. The liquid crystal panel 222 is driven in accordance with an image signal for R light to modulate the R light depending on a driven state of the liquid crystal panel 222. One incident-side polarizer 223 is disposed on the incident side of the liquid crystal panel 222, and R light is irradiated onto the liquid crystal panel 222 through the incident-side polarizer 223. Further, one output-side polarizer 224 is disposed on the output side of the liquid crystal panel 222, and R light emitted from the liquid crystal panel 222 is entered into the output-side polarizer 224.

B light, G light, and R light modulated by the liquid crystal panels 209, 214, and 222 are transmitted through the output-side polarizers 211, 216, and 224, and entered into a dichroic prism 225. The dichroic prism 225 reflects B light and R light, and transmits G light, out of the B light, the G light, and the R light, to thereby combine the B light, the G light, and the R light. Thus, image light after the color combination is projected toward the projection lens unit 30 from the dichroic prism 225.

The projection lens unit 30 is provided with a certain number of lenses, and is adapted to enlarge and project the entered image light onto a screen. The projection lens unit 30 is configured as a short focal length type, and a large sized lens 311 is included at a front end of the projection lens unit 30. Image light is emitted slightly obliquely upward from the lens 311.

The projection lens unit 30 is further provided with a focus ring 312. The focus ring 312 is formed with a focus lever 313. When the focus lever 313 is operated, the focus ring 312 is pivotally moved, and a focus lens (not shown) disposed in the projection lens unit 30 is moved in association with the focus ring 312. Thus, by operating the focus lever 313, focus for a projected image is adjusted.

Referring back to FIG. 2A, the main power source unit 40 is disposed on the right side of the projection lens unit 30, and the sub power source unit 50 is disposed on the left side of the projection lens unit 30. The main power source unit 40 is provided with a power source circuit within a housing 401, and supplies an electric power to each of the electrical components of the projector. The housing 401 is formed with a vent 402 constituted of multitudes of holes on a side surface thereof on the side of the projection lens unit 30. Another vent (not shown) is formed on the opposite side surface of the housing 401.

The sub power source unit 50 is provided with a noise filter and a smoothing circuit, is adapted to remove noises from an AC power provided from a commercial power source. The sub power source unit 50 supplies the noise removed AC power to the main power source unit 40.

The cooling unit 60 is disposed behind the optical engine 20. The cooling unit 60 is provided with plural air intake fans. An air inlet portion 601 of the cooling unit 60 is formed at a rear end of the lower cabinet 11. A filter unit 90 is detachably attached to the air inlet portion 601. The filter unit 90 has plural filters of different mesh sizes to stepwise remove dusts or fumes in an external air drawn in through the air inlet 127 by the filters depending on the mesh sizes.

The cooling unit 60 supplies an external air drawn in through the air inlet 127 of the main body cabinet 10 to the main heat generating parts of the optical engine 20 such as the liquid crystal panels 209, 214, and 222 to thereby cool the heat generating parts.

The exhaust fan unit 70 is disposed on the right side of the main power source unit 40, and at a right end of the lower cabinet 11. The exhaust fan unit 70 is constituted of a first exhaust fan 701, a second exhaust fan 702, and a fan holder 703 for fixedly holding the first exhaust fan 701 and the second exhaust fan 702 to the lower cabinet 11.

The first exhaust fan 701 has an air in-take surface thereof being tilted slightly obliquely rearward with respect to the left side surface of the main body cabinet 10. The first exhaust fan 701 discharges to the outside an air that has been warmed by cooling the heat generating parts (such as the liquid crystal panels 209, 214, and 222; and the light source lamp 201) inside the optical engine 20. The first exhaust fan 701 also discharges to the outside an air that has been drawn in through the air inlet 111 and warmed by cooling the projection lens unit 30.

The second exhaust fan 702 has an air in-take surface thereof being directed to the main power source unit 40. The second exhaust fan 702 discharges to the outside an air that has been warmed by cooling the main power source unit 40.

Referring to FIG. 2B, the control circuit unit 80 is disposed on the side of the left side surface of the lower cabinet 11. The control circuit unit 80 is constituted of a circuit board 801, and an AV terminal substrate 802 mounted on a left end of the circuit board 801.

The circuit board 801 has a rectangular shape, with a front end and a rear end thereof extending along the longitudinal direction thereof. The circuit board 801 is mounted with a control circuit for controlling various driving components such as the liquid crystal panels 209, 214, and 222; and the light source lamp 201. The circuit board 801 is disposed above a part of the projection lens unit 30, a part of the optical engine 20, and a part of the cooling unit 60 with a relatively small clearance.

Various AV terminals 803 are mounted on the AV terminal substrate 802. As described above, when the upper cabinet 12 is mounted on the lower cabinet 11, the AV terminals 803 are exposed on the AV terminal portion 125.

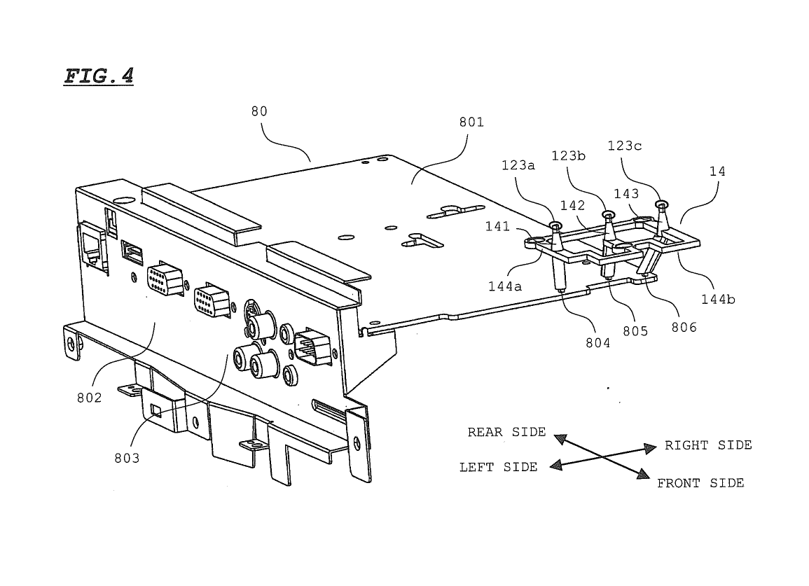

FIG. 4 is a diagram showing a positional relation between LEDs 804, 805, and 806 disposed on the circuit board 801, and a light guiding member 14. FIG. 4 shows only the control circuit unit 80, the light guiding member 14, and the three display windows 123a, 123b, and 123c; and illustration of the other constituent elements is omitted to simplify the description.

The first LED 804, the second LED 805, and the third LED 806 are disposed on the circuit board 801. The first LED 804 is positioned immediately below the first display window 123a. The second LED 805 is positioned slightly rearward of the position immediately below the second display window 123b. The third LED 806 is positioned slightly leftward of the position immediately below the third display window 123c. The first LED 804, the second LED 805, and the third LED 806 are LEDs which are configured to emit light of different colors, such as red light and green light.

The light guiding member 14 is disposed between the LEDs 804, 805, 806; and the display windows 123a, 123b, and 123c. The light guiding member 14 is integrally formed with a first light guiding portion 141, a second light guiding portion 142, a third light guiding portion 143, and two connecting portions (a first connecting portion 144a and a second connecting portion 144b) for connecting between the first light guiding portion 141, the second light guiding portion 142, and the third light guiding portion 143. The light guiding member 14 is made of a transparent resin material such as acrylic resin.

The first light guiding portion 141 guides light emitted from the first LED 804 to the first display window 123a. The second light guiding portion 142 guides light emitted from the second LED 805 to the second display window 123b. The third light guiding portion 143 guides light emitted from the third LED 806 to the third display window 123c.

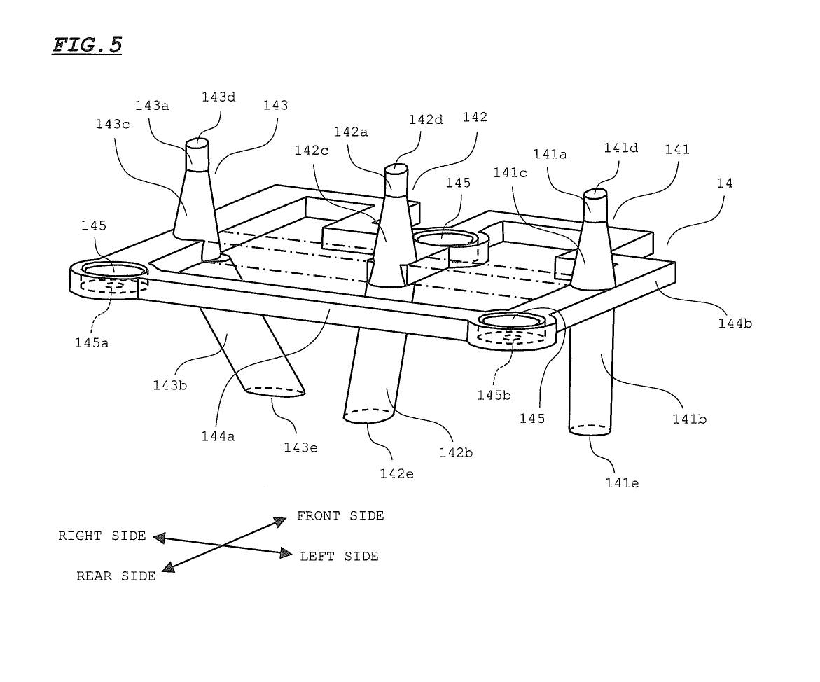

FIG. 5 is a diagram showing an arrangement of the light guiding member 14.

Referring to FIG. 5, the light guiding portion 141, 142, 143 is constituted of an upper columnar portion 141a, 142a, 143a to be received in the display window 123a, 123b, 123c; a lower columnar portion 141b, 142b, 143b for guiding light from the LED 804, 805, 806 toward the upper columnar portion 141a, 142a, 143a; and a tapered portion 141c, 142c, 143c for connecting the upper columnar portion 141a, 142a, 143a and the lower columnar portion 141b, 142b, 143b, and for guiding light from the lower columnar portion 141b, 142b, 143b to the upper columnar portion 141a, 142a, 143a.

The upper columnar portion 141a, 142a, 143a is a columnar member having substantially the same cross sectional shape as the display window 123a, 123b, 123c. In this embodiment, the display window 123a, 123b, 123c has a circular shape, and the upper columnar portion 141a, 142a, 143a has a circular columnar shape in accordance with the shape of the display window 123a, 123b, 123c. Further, the height of the upper columnar portion 141a, 142a, 143a is set to substantially the same value as the thickness of the upper surface 12U of the upper cabinet 12. An upper end surface of the upper columnar portion 141a, 142a, 143a serves as a distal end surface 141d, 142d, 143d of the light guiding portion 141, 142, 143.

The lower columnar portion 141b, 142b, 143b has a circular columnar shape, and the cross sectional area thereof is set larger than the cross sectional area of the upper columnar portion 141a, 142a, 143a. The lower columnar portion 141b of the first light guiding portion 141 has a cross section thereof formed into a true circular shape, and extends upright in a vertical direction in the same manner as the upper columnar portion 141a. The lower columnar portion 142b of the second light guiding portion 142 has a cross section thereof formed into an oval shape, with the length in front and rear directions being slightly longer than the length in left and right directions. As described above, since the second LED 805 is disposed slightly rearward of the position immediately below the second display window 123b, the lower columnar portion 142b extends slightly obliquely rearward with respect to the upper columnar portion 142a. The lower columnar portion 143b of the third light guiding portion 143 has a cross section thereof formed into an oval shape, with the length in left and right directions being slightly longer than the length in front and rear directions. As described above, since the third LED 806 is positioned slightly leftward of the position immediately below the third display window 123c, the lower columnar portion 142b extends slightly obliquely leftward with respect to the upper columnar portion 143a. A lower end surface of the lower columnar portion 141a, 142b, 143b serves as a base end surface 141e, 142e, 143e of the light guiding portion 141, 142, 143.

The tapered portion 141c, 142c, 143c has a tapered shape (conical shape) so that the cross sectional area thereof is gradually (continuously) reduced, as the light guiding portion 141, 142, 143 extends from the side of the lower columnar portion 141b, 142b, 143b toward the side of the upper columnar portion 141a, 142a, 143a.

The first connecting portion 144a and the second connecting portion 144b connect the light guiding portions 141, 142, and 143 at root portions of the tapered portions 141c, 142c, and 143c, respectively. The first connecting portion 144a and the second connecting portion 144b are integrally formed with the light guiding portions 141, 142, and 143.

The first connecting portion 144a connects between the first light guiding portion 141 and the third light guiding portion 143. The second connecting portion 144b connects between the first light guiding portion 141, the second light guiding portion 142, and the third light guiding portion 143. Specifically, the second connecting portion 144b connects all the three light guiding portions 141, 142, and 143 in a direction intersecting with the extending direction of the light guiding portions 141, 142, and 143.

The first connecting portion 144a extends rearward from the first light guiding portion 141, is bent rightward, extends to a rear position of the third light guiding portion 143, is bent forward, and is connected to the third light guiding portion 143.

The second connecting portion 144b extends forward from the first light guiding portion 141, is bent rightward and extends by a certain length, and then, is bent forward and extends by a certain length. The second connecting portion 144b is then bent rightward, extends to a front position of the second light guiding portion 142, is bent rearward, and is connected to the second light guiding portion 142. Then, the second connecting portion 144b is branched out at a certain position of an extension extending from the front position to the second light guiding portion 142, and extends rightward. Thereafter, the second connecting portion 144b is bent forward and extends by a certain length. Then, the second connecting portion 144b is bent rightward, extends to the front position of the third light guiding portion 143, is bent rearward, and is connected to the third light guiding portion 143.

As shown by the one-dotted chain line in FIG. 5, the second connecting portion 144b may be configured with a most simplified structure by linearly connecting the three light guiding portions 141, 142, and 143. However, in the case where the second connecting portion 144b is configured as shown by the one-dotted chain line in FIG. 5, for instance, light which has leaked from one of the light guiding portions to the second connecting portion 144b is likely to propagate to a light guiding portion adjacent to the one light guiding portion through the second connecting portion 144b. In such a case, light may leak through a display window which is not intended to emit light.

In this embodiment, the second connecting portion 144b is configured to connect the light guiding portions adjacent to each other by a detour path, in place of connecting the light guiding portions adjacent to each other by a straight path. With this arrangement, since a light propagation path can be extended, it is no or less likelihood that light which has leaked from one of the light guiding portions to the second connecting portion 144b may be propagated to an adjacent light guiding portion, resulting from attenuation or leakage to the outside during propagation through the second connecting portion 144b.

The first connecting portion 144a is formed with two circular recesses 145. Further, the second connecting portion 144b is formed with one circular recess 145. A small hole 145a is formed in a bottom of each of the recesses 145.

The light guiding member 14 is mounted on the back surface of the upper surface 12U of the upper cabinet 12. When the upper cabinet 12 is mounted on the lower cabinet 11, the light guiding member 14; and the three LEDs 804, 805, and 806 have a positional relation as shown in FIG. 4.

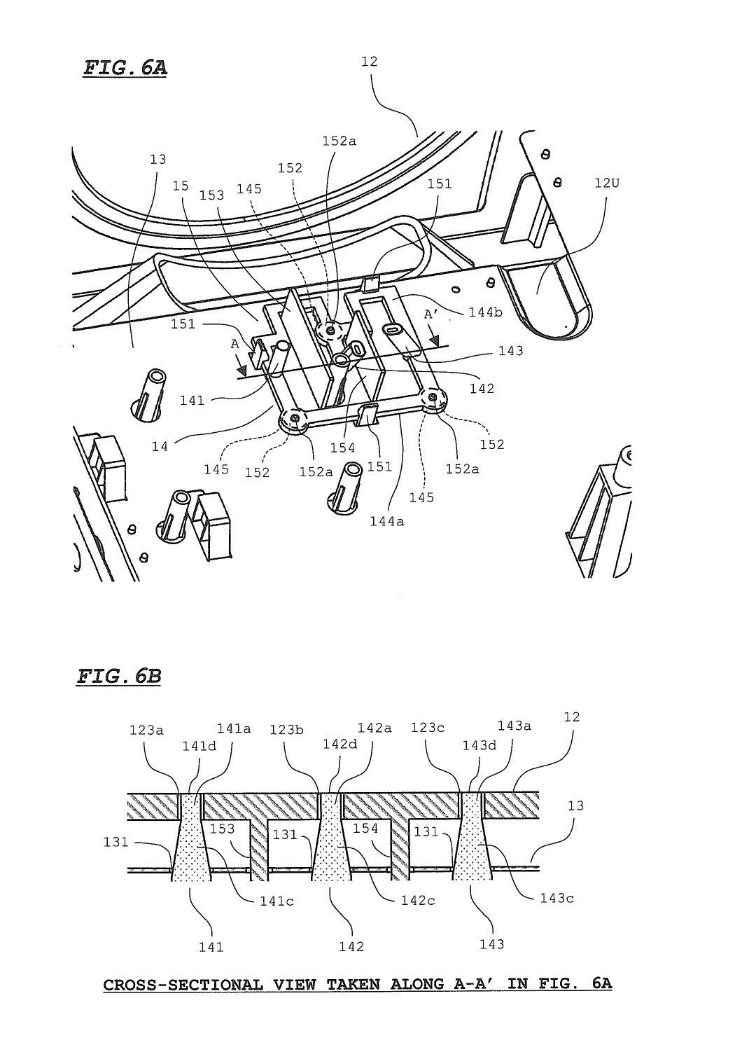

FIGS. 6A and 6B are diagrams for describing a structure as to how the light guiding member 14 is mounted on the upper cabinet 12. FIG. 6A is a perspective view of essential parts, when viewed from the back side of the upper cabinet 12, and FIG. 6B is a cross-sectional view taken along the line A-A′ in FIG. 6A. FIG. 6B shows a state that the upper cabinet 12 is located on the upper side.

Referring to FIG. 6A, a metal shield plate 13 is attached to the back surface of the upper surface 12U of the upper cabinet 12. The shield plate 13 blocks an electromagnetic wave which has been generated from the electronic components inside the main body cabinet 10 and may leak to the outside.

The light guiding member 14 is fixed to a fixing portion 15 corresponding to the indicator portion 123, with the shield plate 13 being interposed between the light guiding member 14 and the upper cabinet 12.

Three claw portions 151, three bosses 152, and two blocking ribs 153 and 154 are formed on the fixing portion 15 in such a manner that these members are exposed on the back surface of the upper cabinet 12. The claw portions 151, the bosses 152, and the blocking ribs 153 and 154 are exposed on the top surface of the shield plate 13 through openings formed in the shield plate 13 in correspondence to the respective parts.

The three claw portions 151 nip the first connecting portion 144a and the second connecting portion 144b of the light guiding member 14 between the three claw portions 151 and the shield plate 13. The three bosses 152 each has a projection 152a on a top surface thereof, and are each engaged in the three recesses 145 formed in the light guiding member 14. In the engagement, the projections 152a are received in the small holes 145a. Thus, the light guiding member 14 is fixed to the upper cabinet 12 by the three claw portions 151 and the three bosses 152.

The blocking rib 153 is formed between the first light guiding portion 141 and the second light guiding portion 142. Further, the blocking rib 154 is formed between the second light guiding portion 142 and the third light guiding portion 143. The blocking ribs 153 and 154 prevent light emitted from one of the LEDs from leaking to the light guiding portion or the display window corresponding to an LED adjacent to the one LED, and being emitted through the adjacent display window.

In this embodiment, the first connecting portion 144a and the second connecting portion 144b are configured to detour from the two blocking ribs 153 and 154. Accordingly, it is possible to set the three light guiding portions 141, 142, and 143 at such positions as not to be obstructed by the blocking ribs 153 and 154. Further, even if light is leaked through a detour portion of the light guiding portions, it is possible to block emission of the leaked light by the blocking ribs 153 and 154.

As shown in FIG. 6B, the tapered portion 141c, 142c, 143c of the light guiding portion 141, 142, 143 passes through the corresponding opening 131 formed in the shield plate 13 in a state that the light guiding member 14 is mounted on the upper cabinet 12. Then, the upper columnar portion 141a, 142a, 143a of the light guiding portion 141, 142, 143 is received in the corresponding display window 123a, 123b, 123c. The distal end surface 141d, 142d, 143d of the light guiding portion 141, 142, 143 is exposed to the outside through the display window 123a, 123b, 123c. The distal end surface 141d, 142d, 143d serves as a light emission surface of the display window 123a, 123b, 123c.

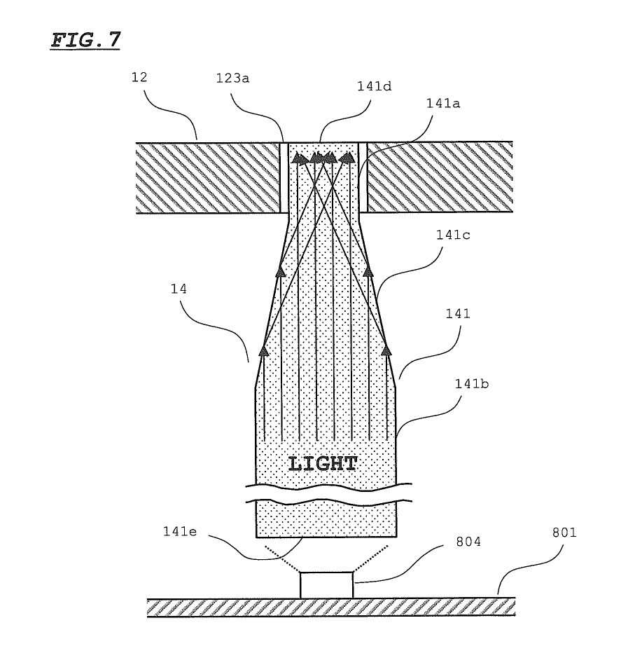

FIG. 7 is a diagram schematically showing a manner as to how light from the first LED 804 is guided to the first display window 123a by the first light guiding portion 141. The manner as to how light is guided by the second light guiding portion 142 and the third light guiding portion 143 is the same as shown in FIG. 7.

Referring to FIG. 7, light emitted from the first LED 804 is entered into a lower end surface of the lower columnar portion 141b serving as an incident surface of the first light guiding portion 141. At the time of light incidence, since the cross sectional area of the lower columnar portion 141b is set larger than the cross sectional area of the upper columnar portion 141a, the incident surface of the lower columnar portion 141b for the light from the first LED 804 is set large. Thus, it is possible to guide a large amount of light from the first LED 804 into the first light guiding portion 141.

Light entered into the lower columnar portion 141b reaches the tapered portion 141c through the lower columnar portion 141b. In this embodiment, the tapered portion 141c has a tapered shape, and a large amount of light impinge on an inner surface of the tapered portion 141c with a small angle, and is reflected on the inner surface, as shown by the arrows in FIG. 7. The reflected light is directed toward the upper columnar portion 141a. Light guided from the tapered portion 141c to the upper columnar portion 141a is emitted to the outside from an upper end surface of the upper columnar portion 141a, in other words, from the distal end surface 141d of the first light guiding portion 141.

In this embodiment, as shown in FIGS. 1A and 1B, the indicator portion 123 is formed on a bulging front portion of the upper cabinet 12. Accordingly, the distance from the LED 804, 805, 806 on the circuit board 801 to the display window 123a, 123b, 123c is increased by the bulging portion, which may make it difficult to efficiently guide light to the display window 123a, 123b, 123c.

However, in this embodiment, the base end surface of the light guiding portion 141, 142, 143 of the light guiding member 14 is set larger than the distal end surface thereof. Accordingly, a large amount of light from the LED 804, 805, 806 is guided into the light guiding portion 141, 142, 143. Further, the light guiding portion 141, 142, 143 is configured so that the cross sectional area thereof is gradually reduced along a path from the base end surface to the distal end surface. Accordingly, as described above, it is possible to guide a large amount of light which has been entered into the light guiding portion 141, 142, 143 to the display window 123a, 123b, 123c without leakage to the outside.

Thus, even if the distance from the LED 804, 805, 806 on the circuit board 801 to the display window 123a, 123b, 123c is increased, it is possible to emit light with a sufficient luminance through the display window 123a, 123b, 123c (in other words, from the distal end surface 141d, 142d, 143d of the light guiding portion 141, 142, 143).

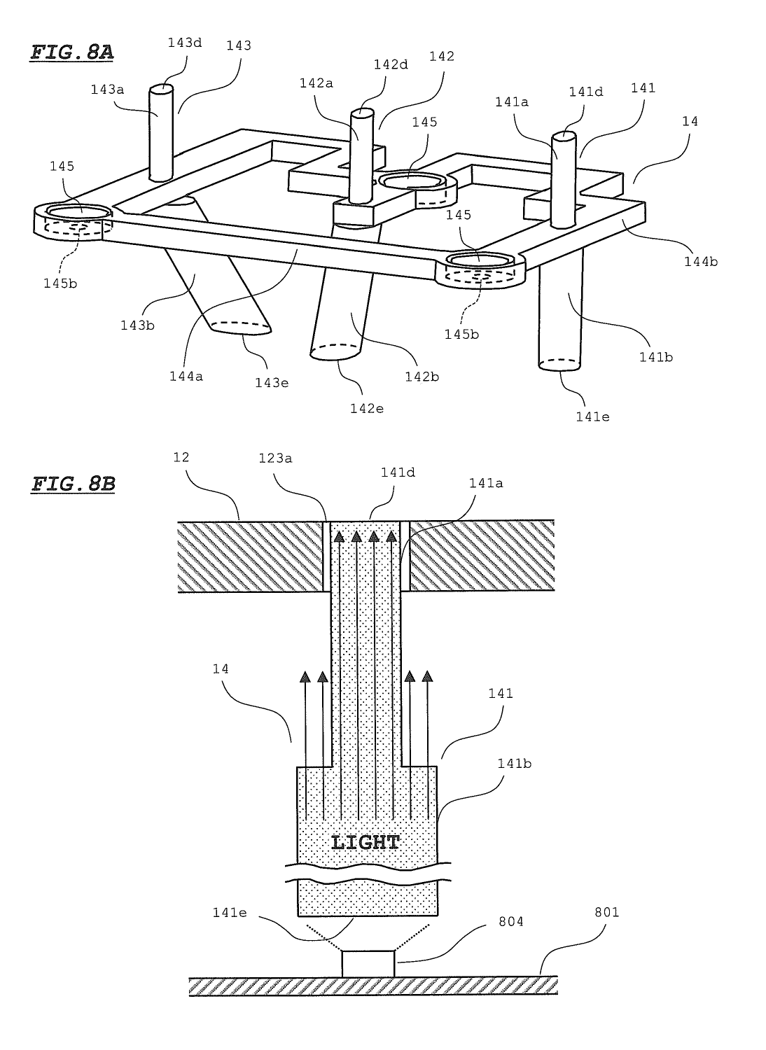

As shown in FIG. 8A, in the case where the light guiding portion 141, 142, 143 is formed only of the upper columnar portion 141a and the lower columnar portion 141b, 142a and 142b, 143a and 143b to maximally guide light from the LED 804, 805,806, the cross sectional area of the light guiding portion 141, 142, 143 is sharply decreased at a connected portion between the upper columnar portion 141a and the lower columnar portion 141b, 142a and 142b, 143a and 143b. In the above configuration, as shown in FIG. 8B, a large amount of light is likely to be leaked to the outside at the connected portion between the upper columnar portion 141a and the lower columnar portion 141b, 142a and 142b, 143a and 143b. As a result, it may be difficult to guide a sufficient amount of light to the upper end surface of the upper columnar portion 141a, 142a, 143a, and it may be difficult to emit light with a sufficient luminance through the display window 123a, 123b, 123c.

On the other hand, as described above, in this embodiment, since the light guiding portion 141, 142, 143 is formed with the tapered portion 141c, 142c, 143c having a tapered shape, it is possible to efficiently guide light which has entered through the LED 804, 805, 806 to the display window 123a, 123b, 123c while suppressing light leakage.

Further, in this embodiment, the second light guiding portion 142 and the third light guiding portion 143 are respectively configured in such a manner that the lower columnar portions 142b and 143b extend obliquely from the positions immediately below the second display window 123b and the third display window 123c to the arranged positions of the second LED 805 and the third LED 806. With this arrangement, even if the second LED 805 and the third LED 806 are disposed at positions displaced from the second display window 123b and the third display window 123c, when viewed from above, it is possible to desirably guide light from the second LED 805 and the third LED 806 to the second display window 123b and the third display window 123c by the second light guiding portion 142 and the third light guiding portion 143, respectively.

The embodiment of the invention has been described as above. The invention, however, is not limited to the foregoing embodiment, and the embodiment of the invention may be modified in various ways other than the above.

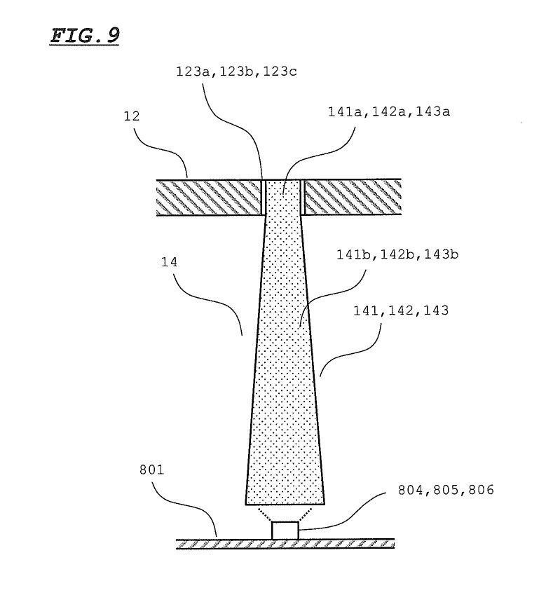

For instance, in this embodiment, the light guiding portion 141, 142, 143 of the light guiding member 14 is configured to have the conical-shaped tapered portion 141c, 142c, 143c between the upper columnar portion 141a, 142a, 143a having a circular columnar shape with a small cross sectional area, and the lower columnar portion 141b, 142b, 143b having a circular columnar shape with a large cross sectional area. Alternatively, as shown in FIG. 9, a light guiding portion 141, 142, 143 may be constituted of an upper columnar portion 141a, 142a, 143a having a circular columnar shape, and a conical-shaped lower columnar portion 141b, 142b, 143b with a lower end surface thereof being formed to have a larger cross sectional area than the cross sectional area of the upper columnar portion 141a, 142a, 143a. With the above modification, it is also possible to receive a large amount of light from the lower end surface (incident surface) of the light guiding portion 141, 142, 143 having a large area to thereby guide the light to the display window 123a, 123b, 123c substantially with no or less light leakage.

Further, in this embodiment, since the second LED 805 is displaced from the second display window 123b and the third LED 806 is displaced from the third display window 123c, when viewed from above, the lower columnar portion 142b of the second light guiding portion 142 and the lower columnar portion 143b of the third light guiding portion 143 are obliquely formed. However, if there is no positional displacement as described above, it is possible to configure the second light guiding portion 142 and the third light guiding portion 143 with the same shape as the first light guiding portion 141.

Furthermore, in this embodiment, the cross sectional area of the tapered portion 141c, 142c, 143c is linearly reduced. Alternatively, the cross sectional area of the tapered portion 141c, 142c, 143c may be non-linearly reduced, as far as the cross sectional area is gradually reduced. It is desirable to form the base end surface 141e, 142e, 143e of the light guiding portion 141, 142, 143 into a concave curved surface. With this arrangement, since the incident angle of light from the LED 804, 805, 806 is increased with respect to the base end surface 141e, 142e, 143e, it is easy to receive light by the light guiding portion 141, 142, 143.

In this embodiment, the indicator portion 123 is formed on the bulging front portion of the upper cabinet 12. The arranged position of the indicator 123 is not limited to the above. However, in the case where the indicator portion 123 is formed on the bulging portion because the lens 311 having a short focal length is disposed, as described in the embodiment, the distance from the LED 804, 805, 806 on the circuit board 801 to the display window 123a, 123b, 123c is increased by the bulging portion, with the result that light is less likely to be guided from the LED 804, 805, 806 to the display window 123a, 123b, 123c. In view of the above, use of the light guiding member 14 of this embodiment is particularly advantageous, in the case where the indicator portion is formed at a position where the main body cabinet is bulged, and the distance from the light emitting portion is increased.

The embodiment of the invention may be changed or modified in various ways as necessary, as far as such changes and modifications do not depart from the scope of the claims of the invention hereinafter defined.

What is claimed is:

1. A display device comprising:
a display window;
a light emitting portion which is disposed away from the display window by a predetermined distance; and
a light guiding portion which is disposed between the display window and the light emitting portion, and which guides light from the light emitting portion to the display window, wherein
the light guiding portion includes a distal end surface located on the side of the display window, and a base end surface located on the side of the light emitting portion, the base end surface having an area larger than an area of the distal end surface, and
at least a part of the light guiding portion is formed into a tapered portion whose cross sectional area is gradually reduced, as the light guiding portion extends from the base end surface toward the distal end surface.

2. The display device according to claim 1, wherein
a plurality of the display windows is formed in the display device,
a plurality of the light guiding portions and a plurality of the light emitting portions are provided in correspondence to the display windows,
the display device further includes a connecting portion which is integrally formed with the light guiding portions, the connecting portion connecting all the light guiding portions in a direction intersecting with an extending direction of the light guiding portions, and
the connecting portion connects the light guiding portions adjacent to each other by a path longer than a path for linearly connecting the light guiding portions adjacent to each other.

3. The display device according to claim 2, further comprising
a light blocking wall which is disposed between the light guiding portions adjacent to each other, wherein
the connecting portion has such a shape as to detour an outer side of the light blocking wall.

4. The display device according to claim 1, wherein
the light emitting portion is disposed at a position displaced from the display window, when viewed from a front direction of the display window, and
at least a part of the light guiding portion extends obliquely from an arranged position of the display window to an arranged position of the light emitting portion.

5. A projection display device comprising:
a main body cabinet;
a display window which is formed in the main body cabinet,
a circuit board which faces the main body cabinet;
a light emitting portion which is disposed on the circuit board at a position away from the display window by a predetermined distance; and
a light guiding portion which is disposed between the display window and the light emitting portion, and which guides light from the light emitting portion to the display window, wherein
the light guiding portion includes a distal end surface located on the side of the display window, and a base end surface located on the side of the light emitting portion, the base end surface having an area larger than an area of the distal end surface, and
at least a part of the light guiding portion is formed into a tapered portion whose cross sectional area is gradually reduced, as the light guiding portion extends from the base end surface toward the distal end surface.

6. The projection display device according to claim 5, wherein
a plurality of the display windows is formed in the display device,
a plurality of the light guiding portions and a plurality of the light emitting portions are provided in correspondence to the display windows,
the display device further includes a connecting portion which is integrally formed with the light guiding portions, the connecting portion connecting all the light guiding portions in a direction intersecting with an extending direction of the light guiding portions, and
the connecting portion connects the light guiding portions adjacent to each other by a path longer than a path for linearly connecting the light guiding portions adjacent to each other.

7. The projection display device according to claim 6, further comprising
a light blocking wall which is disposed between the light guiding portions adjacent to each other, wherein
the connecting portion has such a shape as to detour an outer side of the light blocking wall.

8. The projection display device according to claim 5, wherein
the light emitting portion is disposed at a position displaced from the display window, when viewed from a front direction of the display window, and
at least a part of the light guiding portion extends obliquely from an arranged position of the display window to an arranged position of the light emitting portion.
